(19) United States
(12) Patent Application Publication
(10) Pub. No.: US 2024/0036799 A1
(43) Pub. Date: Feb. 1, 2024

(54) METHOD FOR DISPLAYING VIDEO IMAGES ON SCREENS AND TRANSLATION AND ROTATION OF THE SCREENS IN A TWO-DIMENSIONAL PLANE AND ITS USE

(71) Applicant: MANKIND NV, Wolvertem (BE)

(72) Inventor: Erik VAN DER BORGHT, Wolvertem (BE)

(21) Appl. No.: 18/257,240

(22) PCT Filed: Dec. 15, 2021
(86) PCT No.: PCT/IB2021/061774

§ 371 Date: Jun. 13, 2023

(30) Foreign Application Priority Data
Dec. 15, 2020 (BE) 2020/5926
Dec. 15, 2020 (BE) 2020/5927

(51) Int. Cl. G06F 3/14; F16M 11/10; F16M 11/04; G09G 3/3208

(52) U.S. Cl. CPC G06F 3/1446; F16M 11/105; F16M 11/043; G09G 3/3208; G09G 2300/026; G09G 2340/0492

(57) ABSTRACT

The present invention relates to a method for displaying video images on screens and translation and rotation of the screens in a two-dimensional plane, comprising periodically sending a video frame from a video server to a screen; periodically reading a desired position of a screen in the two-dimensional plane by a control unit from a sequence of desired positions, wherein a control unit, after reading, drives a first servo motor for translation of a screen and a second servo motor for rotation of a screen; wherein a video server and a control unit use the same time period to periodically send a video frame and periodically read a desired position, and a video server and a control unit send a first video frame and read a first desired position after receiving a start signal from a control application. The invention also relates to a use of the method for art installations and events.

### TECHNICAL FIELD

The invention relates to a method for displaying video images on screens and translation and rotation of screens in a two-dimensional plane.

In a second aspect, the invention also relates to a use for art installations and events.

### PRIOR ART

Video is regularly used at events and modern art installations. To make this video attractive, not only movement in the video is used, but also the video itself is moved. As a result, a relationship between movement in the video and the movement of the video can be suggested.

One possible way in which this can be realized is by using a large video screen with very high resolution. Examples of such large video screens are modular LED walls and projection screens with one or more video projectors. By using only a part of the resolution for displaying a video image at a time and leaving the rest, for example, black, and by changing the position of the video image from frame to frame on the video screen, the desired effect is obtained.

Another possible way is through the use of a rotatable video projector and a projection screen. This is a video projector that can be rotated about at least two axes. Rotating the video projector about one or both axes moves the video image on the projection screen.

The first known manner has the disadvantage that a large and expensive video installation is required, wherein a large part of the resolution of an LED wall or projection screen is not used, while these pixels still have to be operated. This is also not an advantageous solution from an energy-saving point of view.

The second known manner has the drawback that by rotating the video projector, the angle at which the video projector projects onto the projection screen constantly changes. This means that, for example, to maintain the same aspect ratio of the image, correction settings on the projector have to be changed from frame to frame, making displaying images very complex. Another disadvantage is that rotations of the projector are controlled by a separate system, so that times when video images are displayed and times when the projector rotates do not necessarily match completely, resulting in a sub-optimal visual effect. For example, it may be desirable for a video image to start translating when a person in the video image starts moving. A third drawback is that a rotatable projector is a standalone device. If, for example, several rotatable projectors are used in an art installation, it is not self-evident to synchronize movements of video images from several rotatable projectors.

Other known prior art methods are described in U.S. Pat. No. 1,789,680 and WO 97/22909.

U.S. Pat. No. 1,789,680 describes a movable platform, wherein a screen is placed at the end of the movable platform.

WO 97/22909 discloses a panoramic screen with a stationary display device and a rotatable support structure.

The present invention aims to solve at least some of the above problems or drawbacks.

### SUMMARY OF THE INVENTION

To this end, the invention provides a method according to claim 1.

The great advantage of this method is that a video frame is periodically sent from a video server to a screen and that a control unit periodically reads a desired position from a predetermined sequence of desired positions, wherein the control unit, after reading the desired position, drives a first servo motor for translation of a screen and a second servo motor for rotation of a screen. Since the video server and the control unit use the same time period to periodically send a video frame and periodically read a desired position, and a video server and a control unit send a first video frame and read a first desired position after receiving a start signal from a control application, movements of the screens and video images are automatically and easily synchronized. Because translatable and rotatable screens are used in this method, it is not necessary to provide a large and expensive video screen with very high resolution, such as modular LED walls and projection screens with one or more video projectors, where an important part of the pixels is not used but is operated, which is an expensive and energy inefficient solution.

Preferred forms of the method are set out in claims 2 to 14.

A specific preferred form of the invention relates to a device according to claim 2.

Here the start signal is sent from a control application to at least two control units and at least one video server, wherein each video server and control unit use the same time period. As a result, at least two translatable and rotatable screens can be easily synchronized in their movements and video images on the screens, which are sent from one or more video servers to the screens, are also synchronized with translations and rotations. This maximizes the visual effect of, for example, an art installation with several translatable and rotatable screens.

In a second aspect, the present invention relates to a use according to claim 15. This use results in an advantageous display of video images on screens, wherein the screens can be translated and rotated and wherein translations and rotations are synchronized with the video images, while no unnecessary pixels have to be operated and expensive hardware has to be used.

### BRIEF DESCRIPTION OF THE DRAWINGS

FIG. 1 shows a schematic overview of software components suitable for carrying out a method according to an embodiment of the present invention.

### DETAILED DESCRIPTION OF THE INVENTION

Unless otherwise defined, all terms used in the description of the invention, including technical and scientific terms, have the meaning as commonly understood by a person skilled in the art to which the invention pertains. For a better understanding of the description of the invention, the following terms are explained explicitly.

In this document, “a” and “the” refer to both the singular and the plural, unless the context presupposes otherwise. For example, “a segment” means one or more segments.

The terms “comprise”, “comprising”, “consist of”, “consisting of”, “provided with”, “include”, “including”, “contain”, “containing”, are synonyms and are inclusive or open terms that indicate the presence of what follows, and which do not exclude or prevent the presence of other components, characteristics, elements, members, steps, as known from or disclosed in the prior art.

Quoting numerical intervals by endpoints comprises all integers, fractions and/or real numbers between the endpoints, these endpoints included.

In the context of this document, ‘aspect ratio’ is the ratio between the width and length of an image. Non-limiting examples are 4:3 and 16:9 aspect ratios.

In the context of this document, movement of a video image or moving of a video image or a moving video image is a change of position where the video image is displayed in a space, as a result of which a movement of the video image is perceived. This is in contrast to a movement in a video image, wherein the position where the video image is displayed in a space does not have to change in order for movement to be perceived in the video image. An example of motion of a video image is an image of a stationary ball, wherein the position where the video image is displayed in a space changes over time, as a result of which a movement of the image of the stationary ball is perceived. An example of a movement in a video image is a video image of a moving ball, wherein a movement of the ball is perceived. It will be apparent that a moving video image can be combined with a movement in the moving video image.

In a first aspect, the invention relates to a method for displaying video images on screens and translation and rotation of the screens in a two-dimensional plane.

In a preferred embodiment, the method comprises the steps of:
periodically sending a video frame from a video server to a screen;
periodically reading a desired position of a screen in the two-dimensional plane by a control unit from a sequence of predetermined desired positions, wherein a control unit, after reading the desired position, drives a first servo motor for translation of a screen and a second servo motor for rotation of a screen.

The screens are preferably screens with a flat display surface. Non-limiting examples are an LCD screen or an OLED screen. The flat display surface lies in a two-dimensional plane. A screen translates along a translation axis in the two-dimensional plane. Preferably, the screen translates along a lying translation axis in the two-dimensional plane. A screen is rotatable about a rotary shaft perpendicular and centrally to the flat display surface of the screen, whereby the screen rotates in the two-dimensional plane.

The video server sends a video frame as an analog or digital video signal to a screen. Consecutive video frames define a video image. A video image may or may not comprise movement in the video image. Non-limiting examples of suitable media for sending video frames from the video server to a screen are Digital Visual Interface (DVI), High-Definition Multimedia Interface (HDMI), Video Graphics Array (VGA), and DisplayPort (DP).

A sequence of predetermined desired positions of a screen is stored in a memory. Preferably, the sequence of desired positions is stored in a memory in the control unit. Preferably, each screen has its own control unit and its own first and second servo motor.

A desired position of a screen is determined in a finite part of the two-dimensional plane. The finite part of the two-dimensional plane is preferably rectangular. A desired position is determined as a first coordinate and a second coordinate. The first coordinate defines a point on the translation axis in the two-dimensional plane, relative to a reference point on the translation axis. The second coordinate defines an oriented angle around the rotary shaft. The oriented angle determines a rotation of a screen about the rotary shaft relative to a reference position of the screen. The reference position determines a zero angle. It will be apparent that a desired position in the sequence of predetermined desired positions may be the same or different from a previous desired position in the sequence of desired positions. It will also be apparent that a desired position may comprise only a translation, only a rotation or a translation and rotation of a screen.

The video server and the control unit use the same unit of time for periodically sending a video frame and periodically reading a desired position. The time period is 20 ms, 16.67 ms, 10 ms, 8.33 ms or any other suitable time period. Preferably, the time period is 20 ms. These time periods are advantageous because they result in a typical video image refresh rate of 50 Hz, 60 Hz, 100 Hz and 120 Hz, respectively.

A video server sends a first video frame, and a control unit reads a first desired position after receiving a start signal from a control application. The start signal can be an electrical or optical signal. The start signal may be a command sent as a message over a network from the control application to a video server and a control unit.

This method is advantageous for automatically synchronizing video images and translations and rotations of a screen, i.e. movements of a video image, in that a video server and a control unit use the same time period to periodically send a video frame and periodically read a desired position, and a video server and a control unit send a first video frame and read a first desired position after receiving a start signal from a control application, whereby a video image and translations and rotations of a screen start at the same time.

An additional advantage is that in this method use is made of translatable and rotatable screens, so that it is not necessary to provide a large and expensive video screen with very high resolution, such as modular LED walls and projection screens with one or more video projectors, in which an important part of the pixels is not used but is operated. A method according to the present invention results in an energy efficient solution using simple and inexpensive screens.

In one embodiment, the control application is run on a separate computer. Preferably, this separate computer is an industrial computer. An industrial computer is advantageous because of its high reliability and robustness, long availability and low consumption. Low consumption is also advantageous because less cooling is required as a result and less disturbing noise is produced by, for example, fans.

In one embodiment, a screen has a minimum resolution corresponding to FHD (1920×1080 pixels), preferably a minimum resolution corresponding to 4K (3840×2160 pixels), even more preferably a minimum resolution corresponding to 8K (7680×4320 pixels). This is advantageous for sharp display of video images at a short distance from a visitor to an event or art installation, so that the visitor does not see individual pixels of the screen.

In one embodiment, the flat display surface of the screen has a diagonal of at least 81 cm, preferably at least 107 cm and more preferably at least 122 cm. The flat display surface of the screen has a diagonal of at most 178 cm, preferably at most 152 cm and more preferably at most 140 cm. A screen with dimensions within this range is large enough to be clearly visible to a visitor from a distance of up to at least 5 m, while the screen is small enough to have a limited weight, at most 30 kg, so that a limited power can be used for the first and second servo motor.

In one embodiment, a video server is a separate server. The video server comprises at least one video output, suitable for sending video frames with a minimum resolution of 4K to a screen. Preferably, the video server comprises at least four outputs, each output being capable of transmitting video frames with a minimum resolution of 4K to a screen.

In an alternative embodiment, a video server is integrated into a separate computer configured to run the control application. The separate computer is as in a previously described embodiment. The separate computer comprises at least four outputs, each output being capable of transmitting video frames with a minimum resolution of FHD to a screen. Preferably, at least one output is suitable for sending video frames with a minimum resolution of 4K to a screen.

In a preferred embodiment, the start signal is sent from a control application simultaneously to at least two control units and at least one video server. Each video server and control unit use the same time period, as in previously discussed embodiments.

Preferably, each control unit is configured for translation and rotation of one screen. A separate control unit for each screen is simple and straightforward to manage and is also advantageous for cabling to screens and control units. Preferably, screens translate and rotate in the same two-dimensional plane. The two-dimensional plane is as in a previously described embodiment.

With high resolution screens, multiple video servers can advantageously distribute a load across the multiple video servers.

This embodiment is advantageous in that as a result at least translations and rotations of at least two translatable and rotatable screens are easily synchronized and video images on the screens, which are sent from one or more video servers to the screens, are also synchronized with translations and rotations. This maximizes a visual effect of, for example, an art installation with multiple translatable and rotatable screens and moving video images.

In a further embodiment, the start signal is sent from a control application simultaneously to four control units, wherein each control unit is configured for translation and rotation of one screen, and wherein each screen can translate and rotate in the same two-dimensional plane.

In a preferred embodiment, the method comprises the additional step of sending a synchronization signal from the control application.

Video images and translations and rotations of a screen are, as previously described, synchronized with each other by a start signal from the control application to a video server and a control unit and a same time period for periodically sending a video frame by a video server and periodically reading a desired position by a control unit. The time period is controlled by a processor in a video server and by a processor or microcontroller in a control unit. Small variations in the time period between the time period on the video server and the time period on a control unit or between time periods on multiple control units or between time periods on multiple video servers, for example due to a deviation in a crystal frequency, can lead to visually visible differences over time between translation and rotation and video frames. An example is a translation that starts before or after a movement in a video image starts, while a simultaneous start of the translation and the movement in the video image is desired. Another example is a first screen that starts moving while a second screen only starts moving afterwards, while here too it was desired that both screens start moving simultaneously. A third example is a first video server that starts sending video frames that comprise a first movement in the video frames, while a second video server only later starts sending video frames that comprise a second movement in the video frames, while it was desired that both servers simultaneously start sending the video frames comprising a movement in the video frames.

By sending a synchronization signal from the control application, a subsequent time period is started on one or more video servers and one or more control units at a time with a maximum deviation of at most 25 ms, preferably at most 15 ms, more preferably at most 10 ms, even more preferably at most 5 ms and even more preferably at most 1 ms. As a result, differences in the time period between video servers and/or control units are not visually visible.

A synchronization signal can be equal to the start signal. A synchronization signal can be a separate signal. The synchronization signal may be an electrical or optical signal. The synchronization signal may be a command sent as a message over a network from the control application to one or more video servers and one or more control units.

A synchronization signal is sent at most 15 minutes after a previous synchronization signal or after a start signal, preferably at most 10 minutes, more preferably at most 5 minutes and even more preferably at most 1 minute.

In a further embodiment, a video server sends audio signals to a control unit. The audio signals comprise a square wave, wherein there is a fixed relationship between the square wave and the time period for periodically sending a video frame and periodically reading a desired period.

The square wave is a periodic signal. The square wave comprises rising and falling edges. The square wave has a period equal to said time period or is a multiple of said time period or a quotient of said time period after dividing said time period by an integer. By detecting rising and/or falling edges and by counting a number of rising and/or falling edges, a subsequent time period can be started on one or more control units at a time with a maximum deviation as in a previously described embodiment relative to the time period on said video server. The use of said audio signals is advantageous because it is not necessary to use specific modules for synchronization. The audio signals may be comprised in a video file. In addition to video frames, the video file comprises said square wave as an audio track. The square wave starts along with a first video frame with a rising or a falling edge. By playing back the video file by the video server, the said audio signals are automatically generated by the video server in synchronization with the video frames and sent to control units.

In case of a period equal to the time period, each subsequent time period on one or more video servers and one or more control units is started upon detection of a rising or falling edge. The choice for a rising or falling edge depends on which edge coincided with the start signal.

In case of a period that is a multiple of the time period, with each rising or falling edge, the start of a new time period is synchronized on one or more video servers and one or more control units. The choice for a rising or falling edge depends on which edge coincided with the start signal. With an even multiple, a new time period on one or more video servers and one or more control units can be synchronized on both the rising and the falling edge. A period for the square wave which is a multiple of the time period may be advantageous to make the period of the square wave inaudible to a human. For example, with a time period of 20 ms and a multiple of ten, the period of the square wave is 200 ms. This results in a frequency of 5 Hz, which is lower than 20 Hz. For an average person, 20 Hz is a lower limit for audible sound waves. Thus, a square wave can be integrated into audio signals that are played along with the video frames, while the square wave is inaudible.

In case of a period that is a quotient of the time period after division by an integer, the rising or falling edges after the start signal are counted and for every multiple of the said integer a new time period is synchronized on one or more video servers and one or more control units. The choice for counting rising or falling edges depends on which edge coincided with the start signal. It will be apparent to a person skilled in the art that rising or falling edges can also be counted modulo X, where X is equal to the integer. A period for the square wave that is a quotient of the time period after division by an integer may be advantageous in making the period of the square wave inaudible to a human. For example, with a time period of ms and an integer of five hundred, the period of the square wave is 40 microseconds. This results in a frequency of 25 kHz, which is higher than 20 kHz. 20 kHz is an upper limit for audible sound waves for an average person. Thus, a square wave can be integrated into audio signals that are played along with the video frames, while the square wave is inaudible.

In one embodiment, the method comprises the additional step of retrieving a file from a storage medium by the control application. The storage medium is a network server, a server in the cloud, a USB stick or external hard drive connected, for example, to a separate computer running the control application. Preferably, the control application stores the file on a local storage medium that is accessible to the control application. A non-limiting example is a local hard drive in a separate computer running the control application. Preferably, the file is encrypted.

The file contains sequences of predetermined desired positions for one or more screens. One sequence preferably corresponds to one screen.

The file contains sequences of video frames for one or more screens. A sequence of video frames is a video file. A video file can be saved in an AVI format, an MPEG format, MPEG-2 format, an MP4 format or any other suitable format. One video file preferably corresponds to one screen.

Alternatively, the file comprises a link to video frames for one or more screens. A link describes where a sequence of video frames, a video file, can be retrieved. This is a storage medium as previously described. This can be the same storage medium as the one for the file, whether or not in the same location on the same storage medium. This can be another storage medium. One link preferably corresponds to one screen.

The file comprises a link between sequences of desired positions and video frames or a link to video frames on the one hand and screens on the other. This means that the link describes which sequence of desired positions and which video frames or link to video frames is intended for which screen.

In a further embodiment, the control application extracts the file. Extracting means that, if necessary, the file is decrypted and that a separate file is created for each sequence of desired positions.

On the basis of the link in the file, the control application sends a sequence of desired positions to the control unit of a screen indicated in the link. This is preferably said separate file per sequence of desired positions.

The control application, based on the link in the file, sends video frames or a link to video frames to the video server of a screen indicated in the link. The video server of a screen is the video server that is connected to the screen via an output. Together with the video frames or the link to the video frames, the control application sends an indication on which screen the video frames should be displayed. Based on this indication, the video server knows on which output the video frames should be sent after the start signal. If a link to the video frames is forwarded to a video server, the video server fetches the video frames itself from the storage medium specified in the link.

In a preferred embodiment, the method comprises the additional step of generating a sequence of desired positions for a screen in an editing program. A discrete timeline is displayed in the editing program. The timeline has a beginning and an end. Discrete steps on the timeline have the same period as the mentioned time period. For example, when a time period of 20 ms is used, corresponding to a refresh rate of 50 Hz, the period between two discrete steps on the timeline is also ms. In the editing program, a number of desired positions for the screen is determined by a user on the discrete timeline. Determining the desired positions can be done textually by entering the desired positions, for instance entering the first and second coordinates as in a previously described embodiment. Determining the desired positions can be done graphically, wherein a graphical representation of the two-dimensional plane is shown on the timeline for each discrete step, wherein a desired position of a screen can be determined by dragging and rotating a graphical representation of a screen in the graphical representation of the two-dimensional plane to the desired position.

It is not necessary for a user to determine a desired position for a screen for each discrete step on the timeline. The editing program interpolates desired positions for discrete steps on the timeline for which the user has not determined a desired position.

It will be apparent to one skilled in the art that desired positions for one or more screens can be determined in the editing program on one timeline.

In a further embodiment, the method comprises the additional step of determining in the editing program an interpolation curve for discrete steps on the timeline for which the user has not determined a desired position. The interpolation curve between two discrete points for which a desired position has been determined can be purely linear. This is the simplest interpolation, but possibly has the disadvantage that screens start a translation and/or a rotation abruptly and at a high speed. The interpolation can take place according to an S-curve between two discrete points for which a desired position has been determined, whereby a screen gradually starts a translation and/or rotation and accelerates and slows down again when the next known position is almost reached. This results in a natural movement of a screen and thus a naturally moving video image. It will be apparent to one skilled in the art that other curves are possible.

Preferably, an interpolation curve can be graphically adjusted in the editing program by means of drag actions.

In a preferred embodiment, the method comprises the additional step of checking the desired positions of multiple screens for each discrete step on the timeline, wherein it is checked whether screens come into contact with each other during a discrete step on the timeline.

The screens translate and rotate in this embodiment in the same two-dimensional plane. By translating and rotating, the screens might touch each other, and the screens become damaged as a result. The editing program knows the desired position of each screen for each discrete step. The editing program knows the dimensions of each screen. The editing program calculates a path taken by each screen from desired position to desired position. Preferably, the editing program calculates at least the path traveled by four vertices of the screen. The editing program checks whether a contour of one screen touches or intersects a contour of another screen during a movement. A contour is preferably a rectangle, defined by the four vertices of the screen. If a contour of a screen touches or intersects a contour of another screen during a movement, the user will be notified.

In a preferred embodiment, the method comprises the additional step of linking video frames to discrete steps on the timeline in the editing program.

The editing program preferably comprises one or more video tracks in the timeline. A video track has a beginning and an end. The beginning of a video track corresponds to the beginning of the timeline and the end of a video track corresponds to the end of the timeline. A video file comprising a sequence of video frames can be loaded into a video track. The video frames in the video file are linked to a discrete step on the timeline, wherein the discrete step to which a video frame is coupled is dependent on a position of the video frame on the video track. Preferably, a sequence of video frames can be cut in the editing program. Cut video frames are no longer linked to a discrete step on the timeline. Preferably, a sequence of video frames may be repeated in the editing program. Preferably, it is possible to switch between different video tracks in the editing program. A video frame of a video track that has been switched to during a discrete step on the timeline is linked to that discrete step on the timeline. Preferably, different video tracks can be mixed in the editing program.

In a further embodiment, the method comprises the additional step of saving a video file, wherein, for each discrete step on the timeline, the video file comprises the video frame linked to it. Preferably, for discrete steps to which no video frame is linked, a black video frame is inserted. Alternatively, video frames are interpolated based on known video frames.

This method is advantageous because by simultaneously starting after a start signal from the control application of translation and rotation of a screen according to the predetermined sequence of desired positions and sending video frames from the video file to the screen, there is automatically a synchronization of video frames displayed on a screen, and translations and rotations of said screen as defined on the timeline in the editing program.

In a preferred embodiment, the method comprises the additional step of creating a virtual canvas in the editing program. The virtual canvas corresponds to the two-dimensional plane in which a screen moves. Dimensions of the virtual canvas are related to dimensions of the finite part of the two-dimensional plane in which a screen moves. The finite part of the two-dimensional plane is rectangular. The virtual canvas has a resolution in a first direction parallel to a first side of the rectangular finite portion of the two-dimensional plane and a resolution in a second direction transverse to the first side of the rectangular finite portion of the two-dimensional plane. The resolution in the first and second directions can be, but need not be, the same. The resolution of the virtual canvas is at least greater than the resolution of a screen. A first video frame fills the entire virtual canvas. The first video frame preferably has a resolution equal to the virtual canvas. If the resolution of the first video frame in the first or second direction is different from the resolution of the virtual canvas, the first video frame can be scaled in the appropriate direction until the resolution is equal. Preferably, the scaling is done while preserving the aspect ratio. Preferably, a video frame is scaled until the entire virtual canvas is filled. When scaling with preservation of aspect ratio and with full filling of the virtual canvas in the first or second direction, if there is an excess of pixels, those pixels are cut away.

Depending on the desired position of a screen in the two-dimensional plane, the editing program selects corresponding pixels from the virtual canvas. When a screen is rotated, it is possible that no corresponding pixels exist between a desired position in the two-dimensional plane and the virtual canvas, because pixels of the screen are positioned in the desired position between pixels of the virtual canvas. In that case, the editing program selects corresponding pixels from the virtual canvas that are closest to the pixels of the screen. In that case, the editing program preferably interpolates corresponding pixels for the screen on the basis of adjacent pixels of the virtual canvas. The corresponding pixels form a second video frame for the screen.

It will be apparent to one skilled in the art that this embodiment can be advantageously combined with previously described embodiments about the editing program. It will also be apparent to one skilled in the art that for each discrete step on the timeline, a different first video frame from a sequence of video frames may fill the virtual canvas, wherein the sequence of video frames may or may not comprise a movement in a video image. In addition, it will also be apparent to one skilled in the art that several screens can be combined in this embodiment.

In a preferred embodiment, the method comprises the additional step of previewing a sequence of desired positions and video frames for a screen in the editing program. The video frames are linked to discrete steps on the timeline as described previously. This embodiment is advantageous for simulating a sequence of desired positions and video frames in the editing program, so that a visual representation of, for example, an art installation can be shown in the editing program, without the need for an installation with one or more translatable and rotatable screens.

In a preferred embodiment, the method comprises the additional step of storing in the editing program sequences of desired positions and video frames or a link to video frames for one or more screens in a file on a storage medium. The file comprises a link between sequences of desired positions and video frames or a link to video frames on the one hand and screens on the other. The storage medium is as in a previously described embodiment about retrieving a file from a storage medium. The file is similar or the same as in a previously described embodiment about retrieving a file from a storage medium. The file is preferably encrypted.

In a preferred embodiment, the method comprises the additional step of calibrating a position of a screen. During calibration, a screen is placed at a known position in the two-dimensional plane. The known position is linked to values which are read from encoders by the control unit of the screen. The encoders are linked to the servo motors for translation and rotation of the screen or integrated into the servo motors for translation and rotation of the screen. This embodiment is advantageous because, for example, an art installation comprising one or more screens can be quickly calibrated after construction, after which one or more screens can be automatically translated and rotated from the known positions to a first position for the screens, so that a sequence of desired positions and a sequence of video frames as defined can be played back.

In a second aspect, the invention relates to a use of a method according to the first aspect for art installations and events. The art installation may or may not be temporary.

This use results in an advantageous display of video images on screens, wherein the screens can be translated and rotated and wherein translations and rotations are synchronized with the video images, while no unnecessary pixels have to be operated and expensive hardware has to be used.

In what follows, the invention is described by way of non-limiting FIGURES illustrating the invention, and which are not intended to and should not be interpreted as limiting the scope of the invention.

### DETAILED DESCRIPTION OF THE DRAWINGS

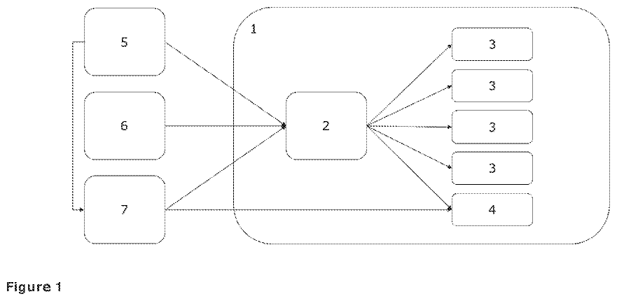

FIG. 1 shows a schematic overview of software components suitable for carrying out a method according to an embodiment of the present invention.

An installation (1) comprises four screens that can translate and rotate in the same two-dimensional plane. The installation (1) comprises an industrial computer on which a control application (2) is executed. The installation (1) comprises for each screen a control unit with a driver (3) for driving a first servo motor for translation of a screen and for driving a second servo motor for rotation of the screen. The installation (1) comprises a separate server on which a video server (4) is run. The video server (4) sends video frames via four outputs to the four screens. Each screen is connected to one specific output. An editing program (5) is run on a computer that is not part of the installation (1). In the editing program (5), a user can define translations and rotations for each of the four screens on a timeline with discrete steps. The translations and rotations are linked to discrete steps on the timeline. In the editing program (5), a user can also link video frames to discrete steps and to a screen. After a user has determined the translations and rotations for each screen and has linked the necessary video frames for each screen to discrete steps on the timeline, in the editing program (5) a sequence of desired positions in the two-dimensional space and a video file, comprising a sequence of video frames, is generated for each screen. The sequences of desired positions and the video files are stored in a file by the editing program (5). Alternatively, instead of video files, only a link to video frames is stored. The file comprises a link between sequences of desired positions and video frames or a link to video frames on the one hand and the four screens on the other. The file is forwarded by the editing program (5) to the control application (2), after which the control application stores the file in a memory of the industrial computer. Alternatively, the file is stored in a file server (7) in the cloud. If the file only contains a link to video frames, the video files for each screen are preferably also stored in a location in the same file server (7). The file server (7) may comprise a library of similar files, and if required, a library of necessary video files. A file can be retrieved by the control application (2) from the file server (7) and stored in a memory of the industrial computer.

Regardless of whether the control application (2) gets a file forwarded from the editing program (5) or retrieves it from a file server (7), the control application (2) will extract the file. Based on the link in the file, the control application (2) sends a sequence of desired positions to the control unit of a screen indicated in the link. The control application (2) sends video frames to the video server (4) based on the link in the file. If the file only comprises a link to video frames, the video server (4) will retrieve the video files comprising the sequences of video frames from the file server (7). The control application (2) simultaneously sends a start signal to the drivers (3) and the video server (4), after which the video server (4) periodically sends a video frame to each of the four screens on the corresponding output and after which each driver (3) periodically reads a desired position for the screen from a sequence of desired positions and drives a first servo motor for translation of a screen and a second servo motor for rotation of a screen. The video server (4) and the drivers (3) use the same time period. Optionally, the start signal is sent from a remotely operated control application (6). The remotely operated control application (6) is a version that runs on a smartphone, tablet or portable computer, wherein the smartphone, tablet or portable computer is preferably connected to the same wireless network as the industrial computer. The remotely operated control application (6) has essentially the same functionality as the control application (2).

1. A method for displaying video images on screens and translation and rotation of the screens in a two-dimensional plane, comprising the steps of:
periodically sending a video frame from a video server to a screen;
periodically reading a desired position of a screen in the two-dimensional plane by a control unit from a sequence of predetermined desired positions, wherein a control unit, after reading the desired position, drives a first servo motor for translation of a screen and a second servo motor for rotation of a screen;
wherein a video server and a control unit use the same time period to periodically send a video frame and periodically read a desired position, and a video server and a control unit send a first video frame and read a first desired position after receiving a start signal from a control application.

2. The method according to claim 1, wherein the start signal from a control application is sent simultaneously to at least two control units and at least one video server, wherein each video server and control unit use the same time period.

3. The method according to claim 1, wherein the method comprises the additional step of sending a synchronization signal from the control application.

4. The method according to claim 1, wherein a video server sends audio signals to a control unit, wherein the audio signals comprise a square wave and wherein there is a fixed relationship between the square wave and the time period for periodically sending a video frame and periodically reading a desired position.

5. The method according to claim 1, wherein the method comprises an additional step of retrieving a file from a storage medium by the control application, wherein the file comprises sequences of desired positions and video frames or a link to video frames for one or more screens and wherein the file comprises a link between
sequences of desired positions and video frames or a link to video frames on the one hand and screens on the other.

6. The method according to claim 5, wherein the control application extracts the file, wherein the control application, based on the link in the file, sends a sequence of desired positions to the control unit of a screen indicated in the link and wherein the control application, based on the link in the file, sends video frames or a link to video frames to the video server of a screen indicated in the link.

7. The method according to claim 1, wherein the method comprises the additional step of generating a sequence of desired positions for a screen in an editing program, wherein a number of desired positions are determined by a user in the editing program on a discrete timeline, where discrete steps on the timeline have the same period as said time period and wherein the editing program interpolates desired positions for discrete steps on the timeline for which the user has not determined a desired position.

8. The method according to claim 7, wherein the method comprises the additional step of determining in the editing program an interpolation curve for discrete steps on the timeline for which the user has not determined a desired position.

9. The method for displaying video images on screens and translation and rotation of the screens in a two-dimensional plane, comprising the steps of:
periodically sending a video frame from a video server to a screen;
periodically reading a desired position of a screen in the two-dimensional plane by a control unit from a sequence of predetermined desired positions, wherein a control unit, after reading the desired position, drives a first servo motor for translation of a screen and a second servo motor for rotation of a screen;
wherein a video server and a control unit use the same time period to periodically send a video frame and periodically read a desired position, and a video server and a control unit send a first video frame and read a first desired position after receiving a start signal from a control application;
wherein the start signal from a control application is sent simultaneously to at least two control units and at least one video server, wherein each video server and control unit use the same time period;
and according to claim 7, wherein the method comprises the additional step of checking the desired positions of multiple screens for each discrete step on the timeline, wherein it is checked whether screens come into contact with each other during a discrete step on the timeline.

10. The method according to claim 7, wherein the method comprises the additional step of linking video frames to discrete steps on the timeline in the editing program.

11. The method according to claim 7, wherein the method comprises the additional step of creating a virtual canvas in the editing program, wherein a first video frame completely fills the virtual canvas, wherein the virtual canvas corresponds to the two-dimensional plane in which a screen moves, wherein the editing program, depending on the desired position of a screen in the two-dimensional plane, selects and/or calculates corresponding pixels from the virtual canvas and wherein the corresponding pixels form a second video frame for the screen.

12. The method according to claim 7, wherein the method comprises the additional step of previewing a sequence of desired positions and video frames for a screen in the editing program.

13. The method according to claim 7, wherein the method comprises the additional step of storing in the editing program sequences of desired positions and video frames or a link to video frames for one or more screens in a file on a storage medium, wherein the file comprises a link between sequences of desired positions and video frames or a link to video frames on the one hand and screens on the other.

14. The method according to claim 1, wherein the method comprises the additional step of calibrating a position of a screen, wherein during calibration, a screen is placed at a known position in the two-dimensional plane, and wherein the known position is linked to values which are read from encoders by the control unit of the screen, wherein the encoders are linked to the servo motors for translation and rotation of the screen or integrated into the servo motors for translation and rotation of the screen.

15. Use of the method according to claim 1 for art installations and events.
